(19) United States
(12) Patent Application Publication
(10) Pub. No.: US 2025/0383656 A1
(43) Pub. Date: Dec. 18, 2025

(54) System and method to optimize control of high voltage disconnector

(71) Applicant: TECHNOLOGIES MINDCORE INC., Terrebonne (CA)

(72) Inventors: Patrick Lalonge, McMasterville (CA); Samuel Asselin, Laval (CA); Lahcen Mejjad, Montreal (CA)

(21) Appl. No.: 19/236,463

(22) Filed: Jun. 12, 2025

Related U.S. Application Data
(60) Provisional application No. 63/659,102, filed on Jun. 12, 2024.

(51) Int. Cl. G05B 23/02; G05B 13/02

(52) U.S. Cl. CPC G05B 23/024; G05B 13/027; G05B 23/0221; G05B 23/0283; G05B 23/0294

(57) ABSTRACT

A method to optimize control of high voltage disconnector is provided. The method comprises capturing data from the disconnect switch, analyzing the failure events based on the captured data using artificial intelligence, calculating and suggesting actions to be performed or maintenance steps to increase lifetime of the disconnect switch. A system to optimize control of high voltage disconnector comprises a plurality of sensing devices such as but not limited to intelligent and high-performance sensors and comprises detection, diagnostic and prognostic modules using the captured data to predict performance and status of the disconnect switch being monitored.

### CROSS-REFERENCE TO RELATED APPLICATIONS

The present patent application claims the benefits of priority of COUNTRY Patent Application No. 63/659,102, entitled “SYSTEM AND METHOD TO OPTIMIZE CONTROL OF HIGH VOLTAGE DISCONNECTOR”, and filed at the United States Patent and Trademark Office on Jun. 12, 2024, the content of which is incorporated herein by reference.

### FIELD OF THE INVENTION

The present invention generally relates to systems and methods to control high voltage disconnectors or disconnect switches, more specifically to systems and methods to optimize control of operations of high voltage disconnectors or disconnect switches, namely using artificial intelligence.

### BACKGROUND OF THE INVENTION

Overhead disconnect switches (ODS) are safety and isolation devices that isolate a part of the electrical network or equipment for specific interventions or maintenance purposes. Such devices also protect personnel and equipment and can be operated at any time when the network is pre-opened by the circuit breaker.

ODS divide a section or element of an electrical network (high voltage line, transformer, substation section, etc.) to allow an operator, locally or remotely, to change the electrical current path of a station or perform maintenance on an element while reducing risks of electric shocks for operators. When in an open position, the ODS must ensure line isolation while in a closed position, the ODS must allow energy transit with minimal losses. The ODS can generally and reliably withstand short-circuit currents without damage or deterioration of nearby equipment. The ODS must remain functional even after long periods of inactivity. Different technologies of disconnect switches are used depending on the voltage level, their application, and their age. An ODS may be manually operated, locally, remotely, or even may be part of network automation.

There are different types of disconnect switches: low voltage (Voltage <1.5 kV), medium voltage (voltage: 1.5 kV-15 kV), and high voltage (Voltage >15 kV).

For about half a century, studies have been conducted on ODS, particularly to establish theoretical models. The motivations were diverse: a) the need to include the electrical performance of disconnect switches as elements of electrical networks to better understand the impact and performance of such apparatus, namely in the context of transitioning to smart grids and massive integration of renewable energies; b) matching experiments and modeling to reduce the number of tests needed for the design and validation of new generations of disconnect switches; c) predicting wear to better manage maintenance and reduce operating costs and risks on the network; and d) studying impacts on equipment (availability and operational efficiency) based on wildlife, weather and seismic hazards.

In the long run, due to exposure to harsh environmental conditions and lack of management and maintenance, various faults and failures may occur during the operation of ODS. According to a study performed by the Conseil international des grands réseaux électriques (CIGRE), the frequency of ODS and grounding switches for voltages equal to or greater than 60 kV where failures occur is about 0.29 failures per 100 components/year. The breaker chamber and the mechanism are the main components that wear out and age poorly. Thermal stresses imposed by load currents cause corrosion and oxidation of several ODS components, and interrupting short-circuit currents causes premature wear of contacts. Environmental stresses such as temperature variations, humidity, frost, or even dust affect mechanical connections; auxiliary components like terminals also age due to electrical stresses. Furthermore, high-voltage components are often subject to the corona effect, an electrical discharge that ionizes the surrounding air and can accelerate the degradation of materials. Other environment conditions may further include nests from different animals or insects, harsh weather including hot and cold temperature variations, snow and/or ice conditions.

Current system used predetermined values which does not use operational or environmental data. Many conditions may thus produce non-optimized operational conditions. As an example, the strength of steel of a disconnector switch varies according to variation of temperatures. As such, movement of the disconnector switch may be different depending on the temperature, which may create unexpected failures events when opening or closing the disconnector gate.

In 2007, the electrical network in Quebec comprised 32,000 disconnect switches in operation. About 16% of such disconnect switches had exceeded their 40-year lifespan. The average age of disconnect switches was about 25 years. According to a study by Hydro-Québec on the malfunction and unavailability of disconnect switches for all voltage levels of the MindCore™ company (formerly known as EHT International), it was found that over 10 years (from 2002 to 2011), the unavailability duration of the disconnect switches in question reached 242,842 hours, due to multiple failures and maintenance work. For disconnect switches with a voltage greater than or equal to 230 kV, the unavailability duration for the same period (10 years) was about 73,186 hours. The main failures were due to refusal to close/open, poor indication, and high resistance. Moreover, poor quality of insulators and mechanical components, imperfect design, poor manufacturing technique of transmission and rotation mechanisms, and assembly and maintenance drawbacks impact the unavailability duration of ODS.

Today, the most popular maintenance strategy for high-voltage equipment is conditional maintenance. As a result, monitoring health status and fault diagnosis are essential to make ODS maintenance smarter and less costly. Currently, methods for monitoring the condition of disconnect switches are mainly based on infrared thermography and ultrasound inspection to detect contact and porcelain insulator faults. Very few studies have been reported on predicting mechanical faults of high-voltage disconnect switches.

There is thus a need for novel system and method for better controlling high voltage electrical disconnector switches which would overcome the drawbacks of the prior art.

There is a further need for novel systems and methods to dynamically control a high voltage disconnector based on sensor data which evolve over time and adapt to the current environmental data and which allows predictive maintenance and/or failure event identification.

### SUMMARY OF THE INVENTION

The shortcomings of the prior art are generally mitigated by a novel system for optimization of overhead electrical disconnect switches and method thereof.

In one aspect of the invention, an ODS is a high voltage type. In some aspects and by way of example only, the ODS may be adapted to work within voltage ranges between 15 kV and 800 kV. In other embodiments, the ODS may be adapted to work within different voltage ranges, such as but not limited to up to 1100 kV. In some embodiments and by way of example only, the nominal currents or currents normally flowing in the disconnect switch may reach 6300 A, at a frequency of 50 Hz-60 Hz. In other embodiments, the nominal currents flowing in the disconnect switch may reach a higher amperage value. In some other aspect, the disconnect switches may work with direct current (DC). In some embodiments and by way of example only, the maximum current, in case of fault, representing the breaking capacity, may reach 80 kA. In other embodiments, the maximum current, in case of fault, representing the breaking capacity, may reach a different amperage value. The ODS may comprise an optical positioning system and a dynamic brake, reduced electrical arc time, temperature and humidity readings.

This invention generally aims providing an intelligent predictive maintenance strategy based on Prognostics and Health Management (PHM) and Condition-Based Monitoring (CBM) techniques to monitor health status of disconnect switches and control operating conditions of the same, making the said disconnect switches more resilient and efficient than prior art apparatuses. The said method is typically used with disconnect switch but could also be applied to similar equipment, such as circuit breakers, electrical transformers, etc.

The objectives of the present invention may comprise better availability and reduction in operation and maintenance time and thus costs through a system health monitoring plan, quicker detection of degradation or performance losses for increased operational efficiency, and improved reliability and safety of ODS and the network. More specifically, a method of prognostics of disconnect switches is provided and may comprise diagnosing and predicting future operational state of disconnect switches relative to a nominal operating mode of reference.

The methods applicable in the field of ODS prognostics generally fall into three categories:
A) Model-based methods. This method generally uses a precise mathematical model which may be derived from physical parameters of the system, and the resulting residues represent the difference between measurements from the real system and outputs from the mathematical model. This method is typically used to detect potential failures of the disconnect switches.
B) Data-driven methods. Such methods use the exploitation and processing of data collected from the system (e.g., voltage, current, temperature, humidity, maximum number of opening and closing cycles, closing position and force, contact resistance, etc.) to better understand the performance and failure modes of the disconnect switch. Such method may further suggest the most appropriate intervention solutions and scenarios amongst different solutions and scenarios.
C) Hybrid methods. Such methods generally combine the advantages of the model-based methods and of the data-driven methods.

Furthermore, developing intelligent predictive maintenance requires implementing artificial intelligence methods and tools to predict and estimate the failure time reliably and selecting the most suitable maintenance strategy for the company's techno-economic objectives. Research focuses on more advanced PHM and CBM techniques, based on machine learning concepts such as artificial neural networks, fuzzy logic, and metaheuristic algorithms, which are better suited to represent the dynamic performance of the disconnect switches. The limitations of these techniques are the burden of the learning phase, parameter updates, and the significant computation time required.

The system's artificial intelligence is trained using a historical dataset that links past sensor readings to known outcomes, such as operational successes or failures. During this learning phase, the model analyzes the data to understand the relationship between specific sensor inputs and their results. This training enables the model to accurately compute control instructions and predict failures when it receives new, live data from the disconnector.

In some aspect of the invention, the system comprises a data acquisition and processing module, fault detection module, isolation system, and diagnosis modules. The system generally allows monitoring and diagnosing the state of an ODS to determine the types of degradation or faults and severity associated to such degradation or faults under normal operating conditions. In yet another aspect of the invention, a PHM system is provided. The PHM is configured to provide prognostics, estimate the remaining useful life of one or more ODS, and making decision or providing data to make decisions regarding implementation of predictive maintenance and associated logistics.

Furthermore, by analyzing, monitoring and/or detecting degradation, faults or failures of the disconnect switch, the resulting estimation or predictions may allow detection or estimate on of failure, faults or degradation of other equipment surrounding or within the same environment of the disconnect switch.

In another aspect of the invention, a system to optimize control of motorized high voltage disconnector is provided. The system comprises a plurality of sensors capable of capturing different types of operational and environmental data relating to the high-voltage disconnector, a data source configured to receive and store the operational and environmental data from the sensors and a processor in data communication with the sensors. The processor is configured to receive the operational and environmental data from the one or more sensors, dynamically compute a control instruction for the high-voltage disconnector based on the received data and to execute the computed control instruction on the motorized high-voltage disconnector.

The sensors may be selected from any one of a temperature sensor, a humidity sensor, a current and voltage detector and an ultrasonic noise sensor, positioning sensors, movement sensors, vibration sensor and sound detector.

The processor may be further programmed to compare the captured data with expected values for a high voltage disconnector, the computing of the control instructions using the comparison, to generate alerts based on the comparison with pre-set thresholds based on equipment availability, performance, and safety criteria, to determine whether the disconnect switch or component of the disconnect switch is degrading and to compute probable failure causes based on the comparison with expected values and/or to predict future state of the disconnector or the components of the disconnector based on the comparison with expected values, on the determination of degradation and on the computed probable failure caused. The probable failure causes may be selected from refusal to open and close, high resistance detection and damaged structure or casing.

The processor may further be programmed to estimate remaining useful life (RUL) of any of components or the disconnect switch, to analyze the computed probable failure causes using a trained artificial intelligence algorithm, to identify a cause/effect relationship between specific characteristics of the disconnect switch and a failure event and/or to identify degradation level of the components or of the disconnector using the artificial intelligence algorithm.

The system may comprise a trained artificial intelligence program configured to compute the control instructions based on the captured sensor data. The trained artificial intelligence program may be configured to use a plurality of neural networks. The processor may be programmed to select the neural networks based on the captured sensors data and/or to compare performance of the neural networks and to change weights of the neural networks based on the comparison.

The processor may be further configured to compare the state of the high voltage disconnector based on the sensors data captured after an operation with predetermined expected state for the same operation.

In another aspect of the present invention, a computer-implemented method to optimize control of a motorized high voltage disconnector is provided. The method comprises capturing and storing operational and environmental data of components of the high-voltage disconnector, computing a control instruction of the high-voltage disconnector based on the captured data to optimize an operation of the disconnector and executing the computed control instruction on the motorized high-voltage disconnector.

The method may further comprise identifying key parameters of operations of the disconnect switch which are likely to determine operating conditions based on the captured data, using probabilistic and stochastic models to extract descriptors used to compare with expected values and/or using a trained artificial intelligence algorithm to compute the control instruction of the high-voltage disconnector based on the captured data.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of system and to optimize control of high voltage disconnector in accordance with the principles of the present invention, showing exemplary sensors adapted to collect data about the operation and status of the disconnector switch.

FIG. 2 is a diagram showing the locations of exemplary high voltage disconnectors in accordance with the principles of the present invention, the disconnector being connected to a network showing that prediction over other equipment may be obtained using data captured on the high voltage disconnector.

### DETAILED DESCRIPTION OF THE INVENTION

A novel system and method to optimize dynamically control of a high voltage disconnector based on sensor data will be described hereinafter. Although the invention is described in terms of specific illustrative embodiments, it is to be understood that the embodiments described herein are by way of example only and that the scope of the invention is not intended to be limited thereby.

The system to optimize control of high voltage disconnector is typically embodied as an embedded “Hardware” system capable of capturing and processing, in real-time, a large volume of operational and environmental data received from the disconnect switches. The data collected from each disconnect switch is used to monitor the disconnect switches, such as but not limited to monitor health status, operational state, availability, and energy consumption of the disconnect switches. In some embodiments, the system comprises a portal accessible to users. The portal is configured to calculate and display data relating to the operation of the disconnect switches under monitoring, such as but not limited to insights, data analysis and interpretation, diagnostic reports, and/or possible intervention scenarios.

The system allows to identify and/or diagnose different failure or malfunctioning events occurring with a high voltage disconnector switch. Event may include but are not environmental stresses such as temperature variations, humidity, frost, or even dust affect mechanical connections, auxiliary components aging like terminals. The events may further include influence of corona effect on the components and other environment conditions such as interference of animals or insects.

The system may further comprise a computer program comprising instructions which may be executed by a computerized device, such as a computer or server. The computer program is generally configured to analyze the collected data and to predict operative scenarios. The computer program may be configured to execute methods based on probabilistic models and artificial intelligence to extract descriptors that initially inform about the presence of an anomaly and/or the initiation of degradation of the monitored disconnector switches. The computer program may be further configured to facilitate maintenance tasks and to provide decision support to operators by executing machine learning algorithms and visualization tools.

In some embodiments, the system comprises a plurality of sensing devices such as but not limited to intelligent and high-performance sensors. The system further comprises a processor, such as a microprocessor-based electronic control boards, a data storage unit and/or wireless communication modules. The system is configured to capture data from the sensors of the disconnect switch, store such data, and process of captured operational and environmental data. The sensors may comprise, but is not limited to, temperature sensor, such as electronic thermometer, humidity sensor, such as electronic hygrometer, current and voltage detector, ultrasonic noise sensor and any capturing device for sensing environmental and operational data of the disconnect switch.

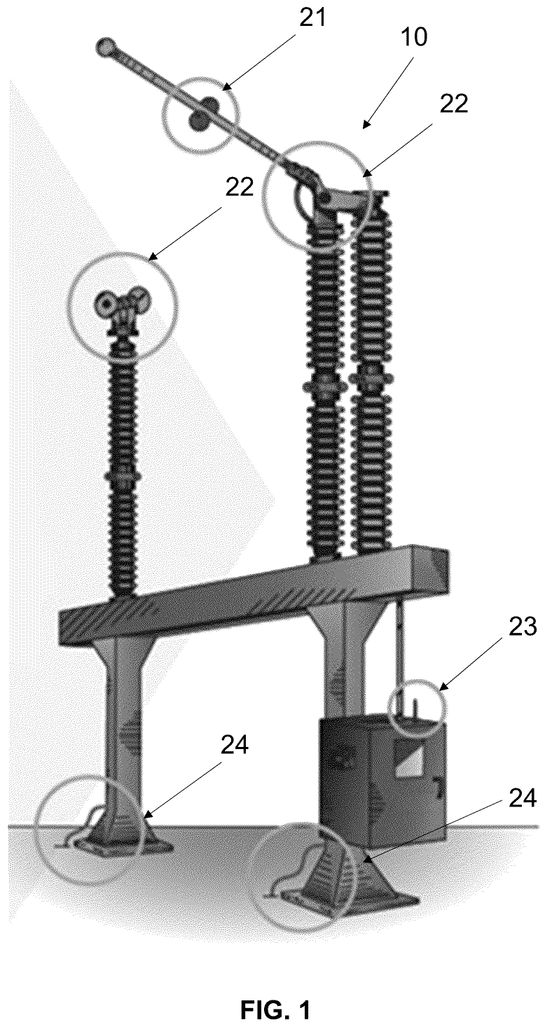

Referring to FIG. 1, an embodiment of a system to optimize control of high voltage disconnector 10 is illustrated. The disconnector switch 10 comprises sensors 20 adapted to collect data about the operation and status of the disconnector switch 10. The disconnector switch 10 may comprise a current sensor 21, a contact temperature sensor 22, a partial discharge sensor 23 and a leakage current sensor 24. Understandably, any other sensor allowing detection of environmental or operations of the disconnect switch may be used within the scope of the present invention, such as but not limited to positioning sensors, movement sensors, humidity sensors, sound detectors, vibration detectors, and/or over-the-air signal detectors.

In some embodiments, the wireless communication modules are capable of securely transmitting real-time data between the sensors and acquisition boards based on the site constraints and weather constraints at the location of the disconnect switches.

The method to optimize control of high voltage disconnector may comprise capturing data from the disconnect switch, analyzing the failure events based on the captured data using artificial intelligence or neural networks, calculating and suggesting actions to be performed or maintenance steps to increase lifetime of the disconnect switch. The method may further comprise reducing and/or cleaning the captured data and protecting the captured data against unauthorized access or cyberattacks. The analysis process and the computation of suggested actions allows dynamically optimizing or controlling the high-voltage disconnector based on the data captured by the sensors 20.

In some embodiments, the failure event of the analysis of the failure events in the operation of disconnect switches may comprise refusal to open and close, detecting high resistance, damaged structure or casing, etc. The analysis of the failure events in the operation of disconnect switches may comprise identifying key parameters of operations of the disconnect switch which are likely to determine the operating conditions of the electrical equipment based on the captured data. The method may use methods based on probabilistic and stochastic models, such as but not limited to Bayesian networks, Markov chains, support vector machines, etc. Such probabilistic and stochastic models may be used to extract descriptors that, on one hand, provide information on the presence of an anomaly and, on the other hand, on initial degradation. In yet other embodiments, such methods may be used to monitor or model the evolution of the monitored disconnect switches state over time.

The system may comprise a detection module. The detection module is configured to use the above-discussed models. The detection module is further configured to compare online data (i.e. extracted descriptors) with certain expected or known values. The detection module is further configured to generate alerts based on pre-set thresholds based on equipment availability, performance, and safety criteria. The system may be configured to analyze the captured data can to increase availability and enhance the reliability of the electrical network and, consequently, reduce operational and maintenance costs of the same. The system may further comprise a diagnostic module in data communication with the detection module. The diagnostic module, based on the detected stated, is configured to determine whether the disconnect switch or one of its monitored components is degraded and suggest probable failure causes (i.e. identification and localization of causes). The diagnostic module is typically in data communication with different components of the disconnector to obtain interactions between the said components, and the operating and environmental conditions of the disconnector.

In some embodiments, the analysis of the failure events based on the captured data uses artificial intelligence and machine learning methods, such as but not limited to neural networks, fuzzy logic, genetic algorithms, etc. The analysis may comprise establishing a prognostic strategy based on the captured data. In such embodiment, the system may comprise a prognostic module configured to use data from the detection and diagnostic modules to predict future state of the disconnectors or one or more of the components being monitored. The prognostic module may further be configured to estimate remaining useful life (RUL) of the component or disconnect switches. The prognostic module is in data communication with the disconnector to establish current state of operation and to predict future usage conditions. As such, the prognostic module may be configured to identify the cause/effect relationship between the specific characteristics of the disconnect switch and/or identify aging or performance degradation process of the same by using predictive algorithms.

In yet other embodiments, the analysis of the failure events may further use neural network combinations, such as but not limited to Artificial Neural Network (ANN)/Recurrent Neural Network (RNN). Any one of the neural network combinations may further be based on metaheuristic algorithms, such as but not limited to Particle Swarm Optimization (PSO), Cuckoo Search (CS) or on Long Short-Term Memory (LSTM). The LSTM may be used in the case of RNN to predict Remaining Useful Life (RUL) and/or monitor the operational state of the disconnect switch. The data collected from the sensors may be used by the system to evaluate the proposed methods and combinations. The analysis of the failure events may further compare performance of the algorithms to adjust the synaptic weights of the neural network (ANN/RNN) and to assess effectiveness of the same in predicting the RUL. Regarding accuracy evaluation, the Mean Square Error (MSE) may be used as the objective function to be optimized by all combinations.

The step to calculate and suggest actions or maintenance steps to be performed generally aims at recommending control/maintenance actions to ensure the disconnect switches operate until the end of life of the apparatus. The step to calculate and suggest actions or maintenance steps typically uses calculated estimates of the RUL. As such, in such embodiment, the system may comprise a presentation module configured to receive data from all the detection, diagnostic and/o prognostic modules. The presentation module is typically embodied as an online Human-Machine Interface (HMI). This HMI generally allows a user or operator to be notified of the normal/abnormal operation of the monitored disconnect switch in the present moment or in the future.

In some embodiment, the step to reduce and/or clean the captured data may comprise reduction, cleaning, and transformation processes. Such processes may be required due to massive data collection. The step to reduce the data may comprise extracting features from the original signal of the sensors or components of the disconnect switch to produce a smaller dataset, resulting in reduced computation time and more comprehensible data.

In some embodiment, the step may use the three-sigma editing rule technique. The three-sigma editing rule technique primarily may compute the difference between each value of the signal and the median value of the signal. After removing outliers, smoothing techniques such as Savitzky-Golay and Wiener filters may be used to transform the data, generally aiming at achieving better signal visualization and at detecting key trends in the data series. The step of reduction may further comprise data reduction. The data reduction may comprise applying iterative clustering methods or a technique known as “support vector machines” (SVM). Understandably, any other known data reduction methods may be used within the scope of the present invention.

The step to protect the captured data against unauthorized access or cyberattacks generally aims at protect the data of the disconnect switch against potential threats or cyberattacks. In some embodiments, the protection step may comprise providing a level of security to the equipment and the communication and information transmission chain using tools such as but not limited to Microsoft™ STRIDE™. Such tools typically protect against six main threats to wireless communication applications: (1) spoofing identity; (2) data tampering; (3) repudiation; (4) information disclosure; (5) denial of service; and (6) elevation of privilege.

In embodiment with a protection mechanism, the system may comprise hardware-based security components, such as but not limited to Trust Module Platform (hardware cryptographic component). The system may further be configured to use unique identification keys for components based on the hardware security module or manufacturer identifiers. The system may further comprise a gateway or firewall protecting the components of the disconnect switch. The system may also comprise user-selected component identifiers verified at each level of the stack, such as at the operating system, gateway and/or cloud levels. The system may further comprise secure boot processes to guard against malware and may use a stack-based security approach. In addition, the system may be configured to provide real-time monitoring of events and potential breaches using security analyses in line with international security standards.

Understandably, any other security process guarding the data against unauthorized accesses may be used within the scope of the present invention. As such, the protection step may use recommendations of the North American Electric Reliability Corporation (NERC).

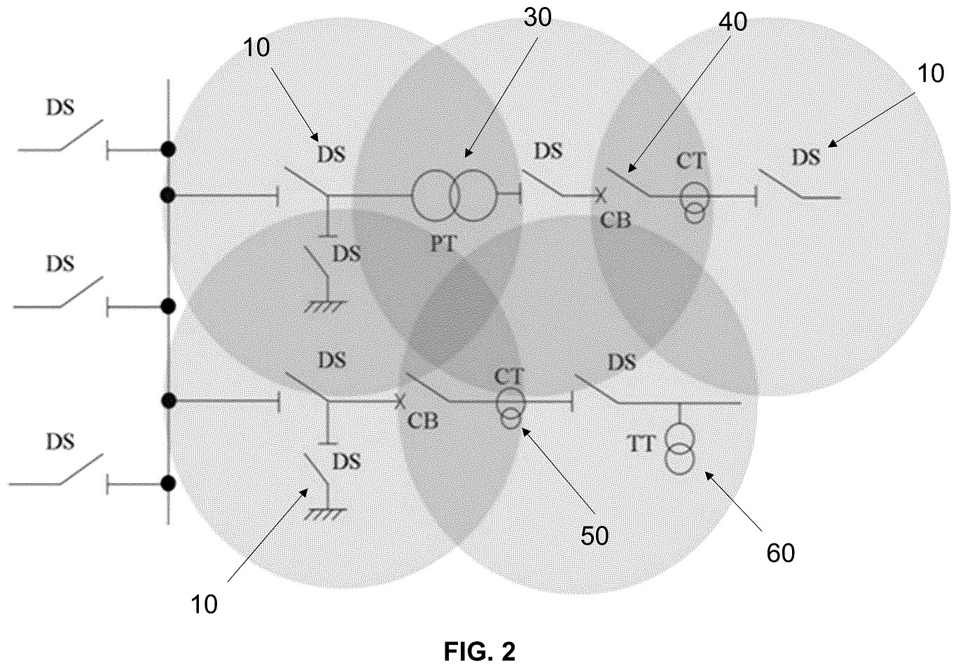

Referring now to FIG. 2, exemplary high voltage disconnectors are illustrated within a network configured to obtain data from sensor which may be used by an AI engine to identify relevant information or conditions of operations of other equipment connected to the network. In such embodiment, three disconnect switches 10 are connected to each phase of the current. Further disconnect switches 10 are connected to a potential transformer (PT) 30, one or more circuit breakers (CB) 40, a current transformer (CT) 50 and/or a ground device (TT) 60. FIG. 2 serves as an illustration and example only that data captured from other equipment of the network may be used to predict failure or maintenance steps to be performed over the disconnect switches 10 (DS) or that data capture by sensors of the disconnect switches may be used to predict failures, degradation or required maintenance steps of other equipment of the network, such as a potential transformer (PT) 30, one or more circuit breakers (CB) 40, a current transformer (CT) 50 and/or a ground device (TT) 60. The different circles shown at FIG. 2 show exemplary impacts of a disconnect switch over near-by or surrounding equipment.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system to optimize control of motorized high voltage disconnector comprising:
a plurality of sensors capable of capturing different types of operational and environmental data relating to the high-voltage disconnector;
a data source configured to receive and store the operational and environmental data from the sensors; and
a processor in data communication with the sensors, the processor being configured to:
receive the operational and environmental data from the one or more sensors;
dynamically compute a control instruction for the high-voltage disconnector based on the received data; and
execute the computed control instruction on the motorized high-voltage disconnector.

2. The system of claim 1, the sensors being selected from any one of a temperature sensor, a humidity sensor, a current and voltage detector and an ultrasonic noise sensor, positioning sensors, movement sensors, vibration sensor and sound detector.

3. The system of claim 1, the processor being further programmed to compare the captured data with expected values for a high voltage disconnector, the computing of the control instructions using the comparison.

4. The system of claim 3, the processor being further programmed to generate alerts based on the comparison with pre-set thresholds based on equipment availability, performance and safety criteria.

5. The system of claim 3, the processor being further programmed to determine whether the disconnect switch or component of the disconnect switch is degrading and to compute probable failure causes based on the comparison with expected values.

6. The system of claim 5, the processor being further programmed to predict future state of the disconnector or the components of the disconnector based on the comparison with expected values, on the determination of degradation and on the computed probable failure caused.

7. The system of claim 6, the probable failure causes being selected from refusal to open and close, high resistance detection and damaged structure or casing.

8. The system of claim 5, the processor being further programmed to estimate remaining useful life (RUL) of any of components or the disconnect switch.

9. The system of claim 6, the processor being further programmed to analyze the computed probable failure causes using a trained artificial intelligence algorithm.

10. The system of claim 9, the processor being further programmed to identify a cause/effect relationship between specific characteristics of the disconnect switch and a failure event.

11. The system of claim 9, the processor being further programmed to identify degradation level of the components or of the disconnector using the artificial intelligence algorithm.

12. The system of claim 1 comprising a trained artificial intelligence program configured to compute the control instructions based on the captured sensor data.

13. The system of claim 12, the trained artificial intelligence program being configured to use a plurality of neural networks.

14. The system of claim 13, the processor being programmed to select the neural networks based on the captured sensors data.

15. The system of claim 13, the processor being programmed compare performance of the neural networks and to change weights of the neural networks based on the comparison.

16. The system of claim 1, wherein the processor is further configured to compare the state of the high voltage disconnector based on the sensors data captured after an operation with predetermined expected state for the same operation.

17. A computer-implemented method to optimize control of a motorized high voltage disconnector, the method comprising:
capturing and storing operational and environmental data of components of the high-voltage disconnector;
computing a control instruction of the high-voltage disconnector based on the captured data to optimize an operation of the disconnector; and
executing the computed control instruction on the motorized high-voltage disconnector.

18. The method of claim 17 further identifying key parameters of operations of the disconnect switch which are likely to determine operating conditions based on the captured data.

19. The method of claim 18 further comprising using probabilistic and stochastic models to extract descriptors used to compare with expected values.

20. The method of claim 17 further using a trained artificial intelligence algorithm to compute the control instruction of the high-voltage disconnector based on the captured data.
